(19) United States
(12) Patent Application Publication
(10) Pub. No.: US 2011/0064834 A1
(43) Pub. Date: Mar. 17, 2011

(54) NOVEL PEST REPELLANT COMPOSITION AND METHOD OF USE

(76) Inventor: Mark Streisfeld, Deerfield Beach, FL (US)

(21) Appl. No.: 12/879,548

(22) Filed: Sep. 10, 2010

Related U.S. Application Data
(60) Provisional application No. 61/242,031, filed on Sep. 14, 2009.

(51) Int. Cl. A01N 65/42; A01P 17/00

(52) U.S. Cl. 424/754

(57) ABSTRACT

The present disclosure relates generally to a novel pest repellant composition for use in repelling reptiles, rodents, birds, insects, and other unwanted pests. Advantageously, this pest repellant composition is safe, effective, economical to produce, and environmentally-friendly. It is used via spreading in an area of interest, for example. The novel pest repellant composition of the present invention generally includes between approximately 97-99% by weight of water, approximately 0.5-1.0% by weight of garlic juice or oil, approximately 0.5-1.0% by weight of neem oil, approximately 0.1 to 0.2% by weight of pepper wax or capsaicin, and approximately 0.1 to 0.2% by weight of a breaker (such as organo-polysiloxane, for example).

### CROSS-REFERENCE TO RELATED APPLICATION(S)

The present non-provisional Patent Application claims priority to U.S. Provisional patent application Ser. No. 61/242,031 filed Sep. 14, 2009 and entitled “NOVEL PEST REPELLANT COMPOSITION,” the contents of which are incorporated by reference in-full herein.

### FIELD OF THE INVENTION

The present invention relates generally to a pest repellant composition and method of use. More particularly, the present invention relates to novel pest repellant composition and method of use for repelling reptiles, rodents, birds, insects, and other unwanted pests in a safe, effective, economical, easy-to-use, and environmentally-friendly manner.

### BACKGROUND OF THE INVENTION

Reptiles, rodents, birds, insects, and other unwanted pests generally present problems for people. For example, iguanas such as in Florida eat and damage landscaping, foliage, gardens, and the like; leave feces which may contact salmonella bacteria; and tunnel and dig under pavers, pool decks, and the like disadvantageously causing washouts and depressions. Further, iguanas and other pests may intrude on boats, decks, homes, swimming pools, storage containers, and the like. For example, squirrels and the like may enter homes during winter for warmth. Disadvantageously, conventional pest repellants typically utilize complex and dangerous chemicals, pose danger for the environment, pose danger for humans and pets, are complex to delivery, and the like. Thus, there exists a need in the art for a safe, effective, economical to produce, easy-to-use, and environmentally-friendly pest repellant composition and method of use.

### BRIEF SUMMARY OF THE INVENTION

In an exemplary embodiment of the present invention, a novel pest repellant composition includes between approximately 97-99 weight% water; between approximately 0.5-1.0 weight% garlic juice or oil; between approximately 0.5-1.0weight% neem oil; between approximately 0.1-0.2 weight% pepper wax or capsaicin; and between approximately 0.1-0.2 weight% breaker. The breaker may include organo-polysiloxane. Optionally, the novel pest repellant composition includes approximately 98.966 weight% water; approximately 0.766 weight% garlic juice; approximately 0.766 weight% neem oil; approximately 0.185 weight% pepper wax; and approximately 0.317 weight% breaker. The novel pest repellant composition may be formed by placing the between approximately 97-99 weight% water in a tank and adding each of the subsequent ingredients thereafter and mixing in the tank. The approximately 0.5-1.0 weight% neem oil and the approximately 0.1-0.2 weight% breaker may be first mixed together in a bucket separate from the tank prior to being added to the water in the tank.

In another exemplary embodiment of the present invention, a novel pest repellant composition is prepared by a process including the steps of: adding an amount of water in a tank; mixing between approximately 0.5-1.0 weight% garlic juice or oil in the tank; mixing between approximately 0.5-1.0 weight% neem oil in the tank; mixing between approximately 0.1-0.2 weight% pepper wax or capsaicin in the tank; and mixing between approximately 0.1-0.2 weight% breaker in the tank. The breaker may include organo-polysiloxane. Optionally, the novel pest repellant composition includes approximately 98.966 weight% water; approximately 0.766 weight% garlic juice; approximately 0.766 weight% neem oil; approximately 0.185 weight% pepper wax; and approximately 0.317 weight% breaker. The approximately 0.5-1.0 weight% neem oil and the approximately 0.1-0.2 weight% breaker may be first mixed together in a bucket separate from the tank prior to being added to the tank.

In yet another exemplary embodiment of the present invention, a method of repelling pests includes providing a pest repellant composition comprising water, garlic juice or oil, neem oil, and pepper wax or capsaicin; and applying the pest repellant composition to an area of interest. The pest repellant composition includes between approximately 97-99 weight% water; between approximately 0.5-1.0 weight% garlic juice or oil; between approximately 0.5-1.0 weight% neem oil; between approximately 0.1-0.2 weight% pepper wax or capsaicin; and between approximately 0.1-0.2 weight% breaker. The breaker may include organo-polysiloxane. The pest repellant composition may be formed by placing the between approximately 97-99 weight% water in a tank and adding each of the subsequent ingredients thereafter and mixing in the tank. The approximately 0.5-1.0 weight% neem oil and the approximately 0.1-0.2 weight% breaker may be first mixed together in a bucket separate from the tank prior to being added to the water in the tank. Optionally, the pest repellant composition includes approximately 98.966 weight% water; approximately 0.766 weight% garlic juice; approximately 0.766 weight% neem oil; approximately 0.185 weight% pepper wax; and approximately 0.317 weight% breaker. The applying step may include spraying the pest repellant with an applicator. The applying step includes a liberal application of the pest repellant, and the method may further include applying a second application of the pest repellant a time period after the liberal application. The method may further include reapplying the pest repellant to the area of interest. Optionally, the area of interest includes any of trees, shrubs, flowers, walkways, docks, roof tiles, pool decks, attic, crawl space, basement, garage, home foundation, siding, and brick.

### BRIEF DESCRIPTION OF THE INVENTION

In various exemplary embodiments, the present invention provides a novel pest repellant composition and method of use for repelling reptiles, rodents, birds, insects, and other unwanted pests. The present invention is a pesticide-free composition that repels pests via a combination of pungent smell and nasty taste. Advantageously, this pest repellant composition is safe, effective, economical to produce, and environmentally-friendly. The pest repellant composition may be distributed via spray bottles, canisters, gallon containers, or the like in a liquid form, and alternatively in granules in a particle form. It is used via spreading in an area of interest, for example. Specifically, the pest repellant composition may be sprayed or the like in the area of interest in its liquid form or spread via granules in its particle form.

Generally, the novel pest repellant composition includes garlic juice or oil, capsaicin (a natural chemical that makes peppers hot), and neem oil forming a combination designed to smell and taste so bad that it encourages the normally voracious iguanas and other pests to disperse. Additional additives may be used to aid with spreading and sticking The novel pest repellant composition of the present invention generally includes between 97-99% by weight of water (e.g., conventional tap water), 0.5-1.0% by weight of garlic juice or oil, 0.5-1.0% by weight of neem oil, 0.1 to 0.2% by weight of pepper wax or capsaicin, and 0.1 to 0.2% by weight of a breaker (such as organo-polysiloxane, for example). Other components may also be utilized.

The garlic juice and pepper wax may include any commercially available product. Neem oil is a vegetable oil pressed from the fruits and seeds of neem (Azadirachta indica), an evergreen tree which is endemic to the Indian subcontinent and has been introduced to many other areas in the tropics. Capsaicin (8-methyl-N-vanillyl-6-nonenamide, (CH₃)₂CHCH=CH(CH₂)₄CONHCH₂C₆H₃-4-(OH)-3-(OCH₃)) is the active component of chili peppers, which are plants belonging to the genus Capsicum. It is an irritant for mammals, including humans, and produces a sensation of burning in any tissue with which it comes into contact.

In one exemplary embodiment, the novel pest repellant composition of the present invention includes approximately 98.966% by weight of water, 0.766% by weight of garlic juice, 0.766% by weight of neem oil, 0.185% by weight of pepper wax, and 0.317% by weight of a breaker (such as organo-polysiloxane). Other components may also be utilized.

The novel pest repellant composition may be formed by mixing the various ingredients described herein. For example, the novel pest repellant composition may be formed by placing the 97-99% by weight of water in a tank or the like. The tank may include an associated mixer and pump with the mixer configured to mix or stir materials, liquids and the like within the tank and the pump configured to add new materials, liquids, etc. to the tank. Alternatively, the novel pest repellant composition may also be formed by using a container or equivalent, manually putting in the materials, liquids, etc., and manually stirring/mixing the materials, liquids, etc. in the container.

With the approximately 97-99% by weight of water in the tank, subsequent ingredients are added therein to form the novel pest repellant composition. The particular order in adding the ingredients may vary. Once the water is placed in the tank, the mixer may be started at a medium speed. The approximately 0.5-1.0% by weight of garlic juice or oil is added, the approximately 0.5-1.0% by weight of neem oil is added, the approximately 0.1 to 0.2% by weight of pepper wax or capsaicin is added, and the approximately 0.1 to 0.2% by weight of a breaker (such as organo-polysiloxane, for example) is added. The approximately 0.5-1.0% by weight of neem oil and the approximately 0.1 to 0.2% by weight of a breaker may first be combined together in a separate mixing container, mixed, and then added to the tank.

In one exemplary embodiment, the pest repellant composition is made by adding approximately 10,973 lbs (4,981,901 ml) of water to a tank. An associated mixer is then set at medium speed and a pump is set at slow speed. Approximately 85.95 lbs (39,019 g) of garlic juice is then added to the tank. Approximately 21 lbs (9,656 ml) of pepper wax is then added to the tank. Approximately 88.07 lbs (39,983 ml) of neem oil and approximately 36.446 lbs (16,547 ml) of breaker (such as organo-polysiloxane) are mixed together in a bucket for approximately 5 minutes and then added to the tank. Finally, mixing is performed until the consistency of the pest repellant composition is uniform. The total yield via this process is 1,320 gallons. It will be readily apparent to those of ordinary skill in the art that this process may be scaled for other yields and that this recipe may be deviated from to a reasonable degree.

Once formed, the novel pest repellant composition is a liquid with a greenish-lime color and a strong garlic odor. Advantageously, none of the ingredients is a hazardous substance as classified by the Environmental Protection Agency under Section 302 extremely hazardous substances, Section 304 CERCLA hazardous substances, Section 312 hazard class, and Section 313 toxic chemicals. The novel pest repellant composition contains no chemicals listed by the state of California under the safe drinking water and toxic enforcement act of 1986 (Proposition 65) as being known to cause cancer, birth defects, or other reproductive harm. Also, the novel pest repellant composition includes no ingredients regulated by the Massachusetts right-to-know law. That is, the novel pest repellant composition is safe towards humans, pets, birds, and even the associated pests. The purpose of the novel pest repellant composition is to repel pests, not to injure or kill the pests.

The novel pest repellant composition was developed to repel pests, and may be used for repelling iguanas, beetles, squirrels, rabbits, frogs, snakes, mealy bugs, deer, armadillos, and the like. The novel pest repellant composition may be used in a liquid form and may be sprayed through an applicator (e.g., spray bottle, canister with a pump, etc.) on practically anything to deter pests. Alternatively, the novel pest composition may be formed as granules and spread about an area of interest. For example, the novel pest repellant composition may be applied to trees, shrubs, flowers, walkways, docks, roof tiles, pool decks, or any other areas where control is desired. Initially, application of a liberal amount of the novel pest repellant composition is most effective. A second, light touch up spray is recommended two to four days after the initial liberal application to reinforce the message that pests are not welcome here. Reapplication is recommended every three to five weeks, depending on the severity of the infestation and amount of rain.

In one exemplary application, the novel pest repellant composition may be used to repel iguanas. For example, the iguana population now numbers in the hundreds of thousands in the southern portion of Florida. Here, the balmy weather keeps the reptiles, which are native to South and Central America, from going any farther north than Orlando. The most abundant iguana is the commonly seen green iguana, “a cute lizard” that lives 15 to 22 years, grows up to 6 feet long, and defecates about a pound of feces a day. Iguanas are becoming a major pest in Florida due to the feces which contains salmonella and because of feasting on decorative plants, such as hibiscus and orchids. Of note, Iguanas may not be trapped and released in Florida anywhere but on your own property.

For managing iguanas, the novel pest repellant composition may be sprayed thoroughly in all areas where iguanas bask, feed, are seen or there is evidence of their presence such as droppings, claw marks or chewed plants. Spray around trees, shrubs, flowers, walkways, docks, roof tiles, pool decks, or any other areas where control is desired. As discussed herein, the novel pest repellant composition is not harmful, and works by producing an odor and taste which is disagreeable to Iguanas and many other garden pests. Initially applying liberal amounts will be most effective. A second, light touch up spray is recommended two to four days after the initial liberal application to reinforce the message that pests are not welcome here. Iguanas are creatures of habit, and as the product is a safe, natural deterrent, it can take several days to a week until the iguanas get the message. Reapplication is recommended every three to five weeks, depending on the severity of the infestation and amount of rain. Optimally, the novel pest repellant composition is applied during dry conditions and should avoid being sprayed directly on tender shoots and flowers during the hottest and sunniest parts of the day. The novel pest repellant composition should be sprayed downwind; any odor will dissipate within 30 minutes.

In another exemplary application, the novel pest repellant composition may be used to repel squirrels, mice, rats, etc. within an attic, crawl space, basement, garage, etc. This is a particular problem with home owners during winter whereby pests seek shelter through miniscule openings in a home. These pests then proceed to make themselves at home. It is often undesirable to plug the openings as the pests may be stuck inside left to die and rot. More advantageously, the novel pest repellant composition may be sprayed within the attic, crawl space, basement, garage, home foundation, siding, brick, etc. and the associated openings to deter the pests and have them leave on their own accord.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A novel pest repellant composition, comprising:
between approximately 97-99 weight% water;
between approximately 0.5-1.0 weight% garlic juice or oil;
between approximately 0.5-1.0 weight% neem oil;
between approximately 0.1-0.2 weight% pepper wax or capsaicin; and
between approximately 0.1-0.2 weight% breaker.

2. The novel pest repellant composition of claim 1, wherein the breaker comprises organo-polysiloxane.

3. The novel pest repellant composition of claim 1, wherein the novel pest repellant composition comprises:
approximately 98.966 weight% water;
approximately 0.766 weight% garlic juice;
approximately 0.766 weight% neem oil;
approximately 0.185 weight% pepper wax; and
approximately 0.317 weight% breaker.

4. The novel pest repellant composition of claim 1, wherein the novel pest repellant composition is formed by placing the between approximately 97-99 weight% water in a tank and adding each of the subsequent ingredients thereafter and mixing in the tank.

5. The novel pest repellant composition of claim 4, wherein the approximately 0.5-1.0 weight% neem oil and the approximately 0.1-0.2 weight% breaker are first mixed together in a bucket separate from the tank prior to being added to the water in the tank.

6. A novel pest repellant composition prepared by a process comprising the steps of:
adding an amount of water in a tank;
mixing between approximately 0.5-1.0 weight% garlic juice or oil in the tank;
mixing between approximately 0.5-1.0 weight% neem oil in the tank;
mixing between approximately 0.1-0.2 weight% pepper wax or capsaicin in the tank; and
mixing between approximately 0.1-0.2 weight% breaker in the tank.

7. The novel pest repellant composition of claim 6, wherein the breaker comprises organo-polysiloxane.

8. The novel pest repellant composition of claim 6, wherein:
approximately 0.766 weight% garlic juice is mixed in the tank;
approximately 0.766 weight% neem oil is mixed in the tank;
approximately 0.185 weight% pepper wax is mixed in the tank; and
approximately 0.317 weight% breaker is mixed in the tank.

9. The novel pest repellant composition of claim 6, wherein the approximately 0.5-1.0 weight% neem oil and the approximately 0.1-0.2 weight% breaker are first mixed together in a bucket separate from the tank prior to being added to the tank.

10. A method of repelling pests, comprising:
providing a pest repellant composition comprising water, garlic juice or oil, neem oil, and pepper wax or capsaicin; and
applying the pest repellant composition to an area of interest.

11. The method of repelling pests of claim 10, wherein the pest repellant composition comprises:
between approximately 97-99 weight% water;
between approximately 0.5-1.0 weight% garlic juice or oil;
between approximately 0.5-1.0 weight% neem oil;
between approximately 0.1-0.2 weight% pepper wax or capsaicin; and
between approximately 0.1-0.2 weight% breaker.

12. The method of claim 11, wherein the breaker comprises organo-polysiloxane.

13. The method of claim 11, wherein the pest repellant composition is formed by placing the between approximately 97-99 weight% water in a tank and adding each of the subsequent ingredients thereafter and mixing in the tank.

14. The method of claim 11, wherein the approximately 0.5-1.0 weight% neem oil and the approximately 0.1-0.2 weight% breaker are first mixed together in a bucket separate from the tank prior to being added to the water in the tank.

15. The method of claim 10, wherein the pest repellant composition comprises:
approximately 98.966 weight% water;
approximately 0.766 weight% garlic juice;
approximately 0.766 weight% neem oil;
approximately 0.185 weight% pepper wax; and
approximately 0.317 weight% breaker.

16. The method of claim 10, wherein the applying step comprises spraying the pest repellant with an applicator.

17. The method of claim 10, wherein the applying step comprises a liberal application of the pest repellant, and further comprising:
applying a second application of the pest repellant a time period after the liberal application.

18. The method of claim 10, further comprising:
reapplying the pest repellant to the area of interest.

19. The method of claim 10, wherein the area of interest comprises any of trees, shrubs, flowers, walkways, docks, roof tiles, pool decks, attic, crawl space, basement, garage, home foundation, siding, and brick.
